(19) United States
(12) Patent Application Publication
(10) Pub. No.: US 2011/0184786 A1
(43) Pub. Date: Jul. 28, 2011

(54) Methodology for Data-Driven Employee Performance Management for Individual Performance, Measured Through Key Performance Indicators

(76) Inventors: Ileana Roman Stoica, Hanover, MN (US); Sorin Roman Stoica, Hanover, MN (US)

(21) Appl. No.: 12/692,636

(22) Filed: Jan. 24, 2010

(51) Int. Cl. G06Q 10/00

(52) U.S. Cl. 705/7.39

(57) ABSTRACT

A methodology for data-driven employee performance management and performance-related compensation (i.e. bonus), measured through key performance indicators, methodology which includes the following steps: setting individual key performance indicators (KPIs) and the respective performance goals associated with said KPIs, establishing performance review frequency (i.e. monthly, quarterly, annually), establishing baseline levels for said KPIs (i.e. value at the end of previous performance review period), establishing ranges for performance ratings (i.e. result <90% of goal leads to a “below expectations” rating), establishing bonus or payout levels associated with each goal's performance level (i.e. “below expectations” performance pays 50%, “exceeds expectations” pays 125%), establishing goal priority, timing, and weighting, calculation of overall performance rating and (bonus) payout level at the end of the review period, and documentation of the results of all the steps listed above.

### BACKGROUND OF THE INVENTION

A good performance management system has the following deliverables:
Has to motivate, engage, and compensate employees based on their individual performance;
Has to reflect the achievement of agreed-upon goals, with their respective priorities, urgencies, and weights;
Has to contribute to employee retention and career path;
Has to be a fair and consistent process.

In the case of traditional methods of performance management, reviews and bonus payouts (or any variable portion of compensation) have a few significant shortcomings:
Traditional performance management methods call for a limited number of goals (no more than 3-4);
Company-wide bonus payouts do not vary (at all, or in any significant manner) with individual performance;
Payouts based on individual performance (i.e. commission structures) are usually based on a very limited number of goals (i.e. sales commission), hence leading to significant challenges in managing performance for complex goals, prioritized, sequential, or cross-functional. For example, sales reps will focus on sales only (to ensure maximum commission), while neglecting customer service duties (bearing no payout);
Finally, performance ratings and related bonus payouts are frequently a source of disputes, conflicts, employee dissatisfaction, low engagement levels, and turnover, even lawsuits, all challenging the fairness and consistency of the traditional methods.

### SUMMARY OF THE INVENTION

This methodology allows, through a straight-forward data-driven system, the achievement of all deliverables without any of the shortcomings described above.

Furthermore, it allows fair compensation for individual performance even in cases where goals and priorities change in the middle of the reporting period.

Using this methodology, data-driven employee performance management and performance-related compensation (i.e. bonus), measured through key performance indicators includes the following steps:
1. setting individual key performance indicators (KPIs) and the respective performance goals associated with these KPIs,
2. establishing performance review frequency (i.e. monthly, quarterly, or annually),
3. establishing baseline levels for said KPIs (i.e. value at the end of previous performance review period),
4. establishing ranges for performance ratings (i.e. result <90% of goal leads to a “below expectations” rating),
5. establishing bonus or payout levels associated with each goal's performance level (i.e. “below expectations” performance pays 50%, “exceeds expectations” pays 125%),
6. establishing goal priority, timing, and weighting,
7. calculation of overall performance rating and (bonus) payout level at the end of the review period,
8. documentation of the results of all the steps listed above.

Using an example to illustrate how this methodology works, we will consider a complex role within a company, bearing multiple, complex goals—a Regional Sales Manager. This role is not unique in the company; there are five Regional Sales Managers, four for the United States and one for Canada. The company has an aggressive growth strategy and wants to encourage, recognize and compensate exceptional performance.

We will follow, one by one, the steps described in the methodology abstract.

Step 1: Setting individual key performance indicators (KPIs) and the respective performance goals associated with these KPIs. FIG. 1 shows individual KPIs set for the period, for the specific individual in our example, complete with goals for each KPI.

Step 2: Establishing performance review frequency (i.e. monthly, quarterly, or annually). We have established quarterly reviews and bonus payouts. In our example, we are setting performance goals for the first quarter of 2009 (Q1 2009).

Step 3: Establishing baseline levels for said KPIs (i.e. value at the end of previous performance review period). We will consider the values of Q4 2008 as baseline values. FIG. 2 shows these baseline values for all selected KPIs.

Step 4: Establishing ranges for performance ratings (i.e. result <90% of goal leads to a “below expectations” rating), and explicitly stating the values of each metric for these ranges. In our example, we are using a “below expectations/meets expectations/exceeds expectations” performance rating, with associated values for targets for each rating. Any such convention for ratings will do, as long as it reflects the three main tiers of performance. Specifically, achieving 100% of a goal puts the employee right in the middle of the “meets expectations” range. Achieving less than 90% of the goal puts the employee at “below expectations”, while exceeding goal by more than 10% (achieving 110%) puts the employee in the “exceeds expectations” range. This is just a convention though; for very challenging goals the range could be a couple of percentage points, instead of 10%. The goals must remain challenging, yet achievable; therefore, part of the goal setting exercise is the agreement between managers and employees as to what these values should be. As long as they are agreed upon, and clearly documented, the methodology works flawlessly in ensuring over performance is recognized and rewarded appropriately.

Step 5: Establishing bonus or payout levels associated with each goal's performance level (i.e. “below expectations” performance pays 50%, “exceeds expectations” pays 125%). In FIG. 3 we are showing the goal ranges as well as the associated bonus levels for each range. This is based on bonus “levels”, i.e. for a manager role bonus level is 20% of their fixed income, for a worker is 10%, and for the CEO is 40%. In our example, achieving 125% bonus means that, in the case of the Regional Sales Manager, if his 100% bonus is 20% of his income, for achieving 125% bonus he will be paid 25% of his fixed income as bonus dollars. Again, any other convention can apply.

Step 6: Establishing goal priority, timing, and weighting. This is a critical step in complex goal environments, where employees could easily hesitate or become less productive if faced with equally weighted yet (apparently) conflicting goals. Goal weighting is a tuning instrument, allowing strict, clearly defined goal prioritization to be achieved by means of motivation. For instance, if goal “A” is weighted 40% versus goal “B”, which is weighted only 5%, our employee will shift focus towards the heavier weighting goal, enabling managers to achieve task prioritization. FIG. 4 shows that the Regional Sales Manager in our example, although tasked with many different responsibilities, will achieve maximum rewards if he focuses on selling and cost savings. Achieving only these three heavily weighted goals ensures 70% of bonus payout. In our example, there is no goal timing.

Step 7: Calculation of overall performance rating and (bonus) payout level at the end of the review period. By inserting a column with actual results achieved at the end of the reporting period, and calculating bonus payout level for each goal based on its weighting, we are able to calculate this employees performance rating at the end of the quarter. As he has achieved 120.63% bonus (or variable pay), this places him in an “exceeds expectations” range, with a three-star rating. FIG. 5 shows all this data, and the manner of documenting it. The formula to calculate payout percentage for each goal is quite simple; based on the ranges we are selecting which bonus level the employee has achieved: 0%, 50%, 100%, or 125%. Then, applying the associated weighting for the specific goal, we have the bonus payout percentage associated with the particular goal and the achieved result for it. As it is a weighted approach allowing stretch targets, the sum of all payouts can exceed 100%. We are also seeing, in this example, how the Regional Sales Manager has “sacrificed” retention, a low-weight goal, and ended below expectations for this particular goal, in favor of heavier-weighted cash-delivering goals, such as sales and cost control.

Step 8: Documentation of the results of all the steps listed above. Complete documentation is shown in FIG. 5. In some cases, for complex measurements, it could prove beneficial to document the method of calculating each metric, to ensure consistency.

Now it becomes evident how this methodology addresses all issues around disputed ratings and/or variable compensation, while allowing a lot of flexibility into driving performance with data-driven precision, allowing leaders to have nimble teams that are focused on delivering results.

### BRIEF DESCRIPTION OF THE DRAWINGS

FIG. 1: Setting, prioritization, and weighting of individual performance goals

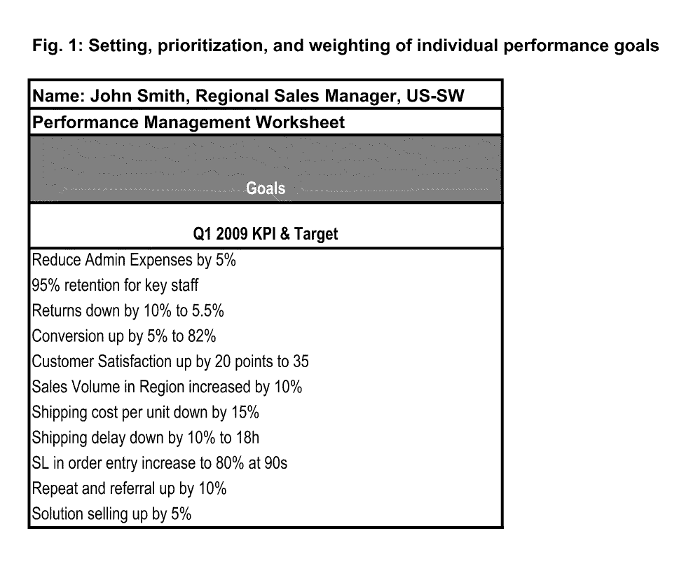

FIG. 2: KPIs with baseline values at the end of previous reporting period

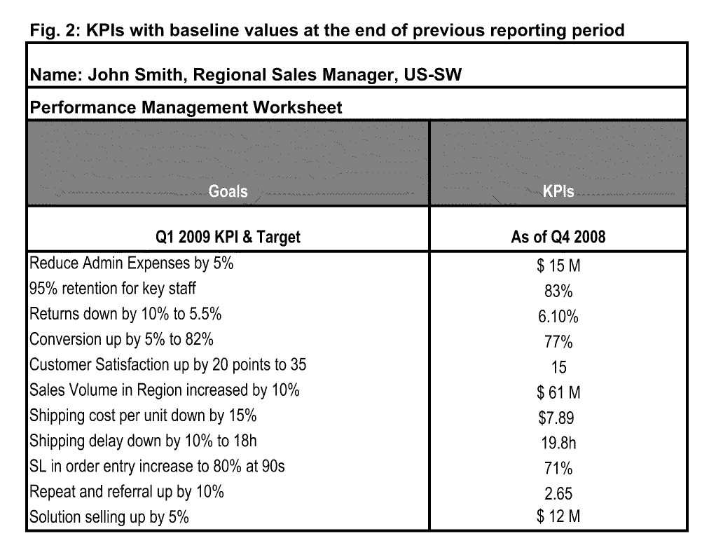

FIG. 3: KPIs with baseline, performance ranges, and bonus payout levels associated with each goal

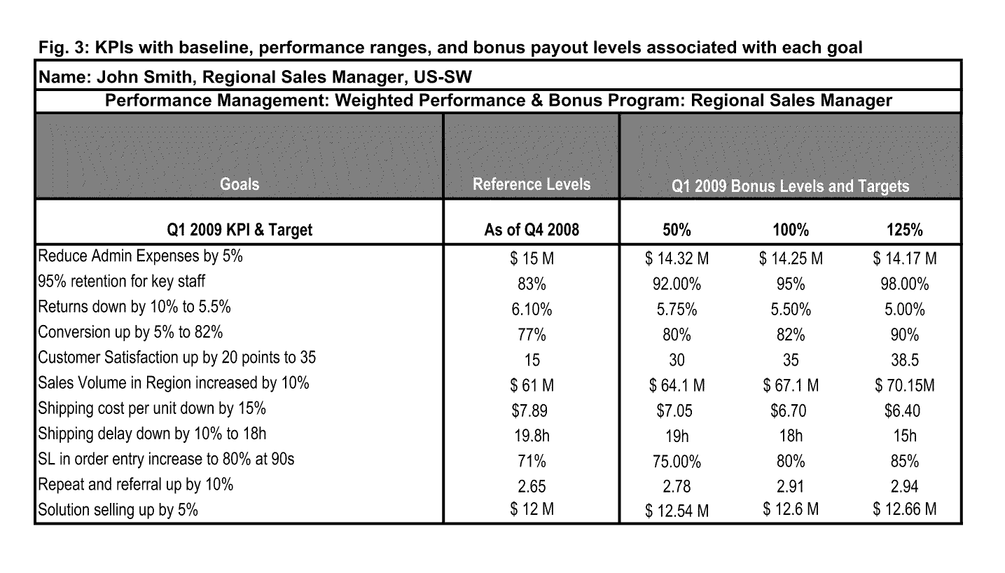

FIG. 4: Introducing goal weighting as a prioritization tool

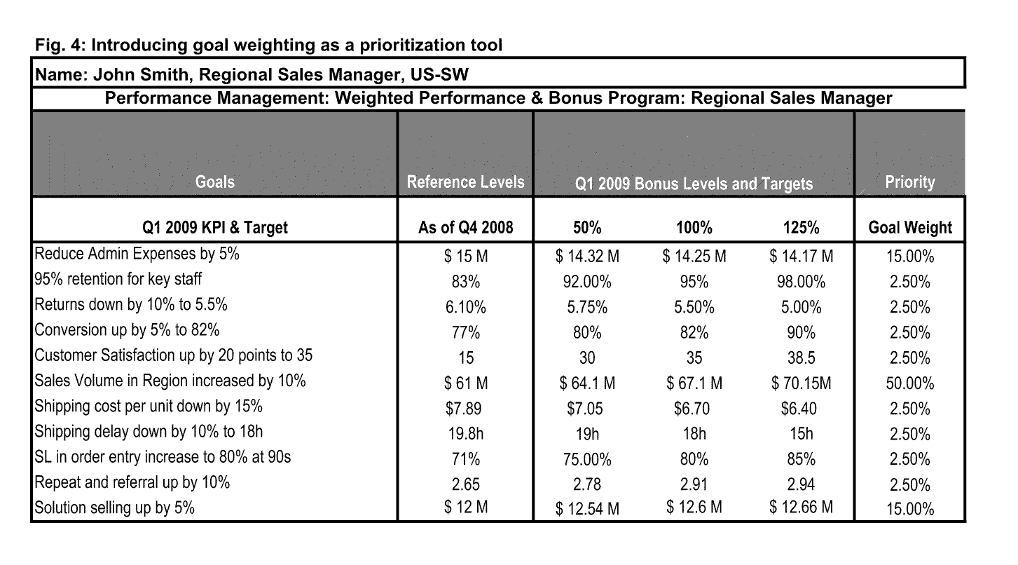

FIG. 5: Performance management chart complete with results, ratings, bonus payouts and star-ratings.

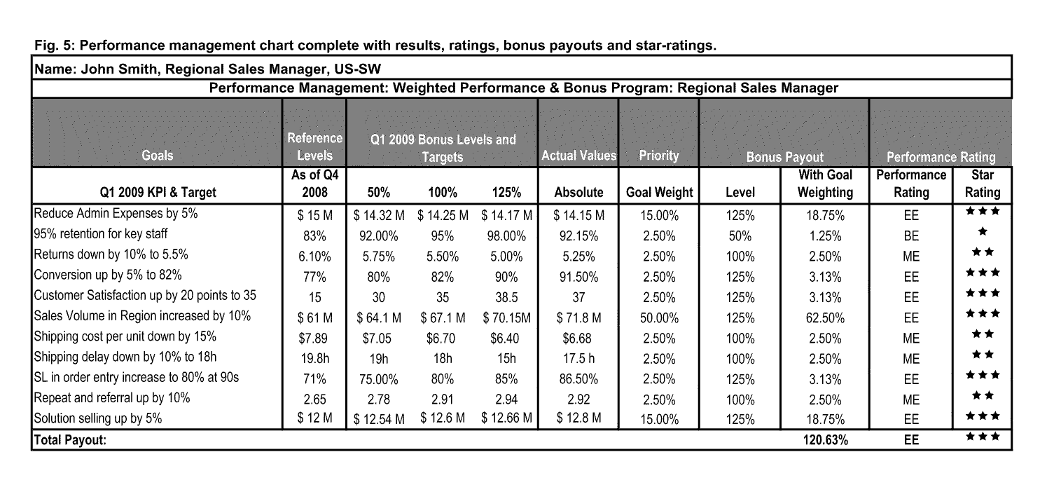

1. A methodology for data-driven employee performance management and performance-related compensation (i.e. bonus, commission), measured through key performance indicators, which includes the following steps: (1) setting individual key performance indicators (KPIs) and the respective performance goals associated with said KPIs, (2) establishing performance review frequency (i.e. monthly, quarterly, or annually), (3) establishing baseline levels for said KPIs (i.e. value at the end of previous performance review period), (4) establishing ranges for performance ratings (i.e. result <90% of goal leads to a “below expectations” rating), (5) establishing bonus or payout levels associated with each goal's performance level (i.e. “below expectations” performance pays 50%, “exceeds expectations” pays 125%), (6) establishing goal priority, timing, and weighting, (7) calculation of overall performance rating and (bonus) payout level at the end of the review period, and (8) documentation of the results of all the steps listed above.

2. The methodology of claim 1, wherein the business goals can be achieved in a sequential or simultaneous manner.

3. The methodology of claim 1, wherein the goals are established for a single or multi-unit business, regardless of the type of business.

4. The methodology of claim 1, wherein the business goals can have equal or different weights.

5. The methodology of claim 1, wherein the target levels established, in conjunction with the results achieved, are used to manage team or business unit performance.

6. The methodology of claim 1, wherein the goals are of a creative nature—i.e. design, research and development, software development, artistic work.

7. The methodology of claim 1, wherein the respective business goals are individual milestones on the path to a larger, more complex goal or deliverable.

8. The methodology of claim 1, wherein the respective performance ratings levels are expressed by means of a symbol rating convention (i.e. star rating, red-yellow-green).

9. The methodology of claim 1, wherein stretch values for goals and payouts are established, to encourage peak performance.

10. The methodology of claim 1, wherein goals are expressed in time limit dates for completion of tasks (i.e. build house by July 1^{st}, implement software by the end of the year).

11. A computerized application for the implementation, documentation, management, and tracking of employee performance using a methodology for data-driven employee performance management and performance-related compensation (i.e. bonus), measured through key performance indicators, which includes the following steps: (1) setting individual key performance indicators (KPIs) and the respective performance goals associated with said KPIs, (2) establishing performance review frequency (i.e. monthly, quarterly, or annually), (3) establishing baseline levels for said KPIs (i.e. value at the end of previous performance review period), (4) establishing ranges for performance ratings (i.e. result <90% of goal leads to a “below expectations” rating), (5) establishing bonus or payout levels associated with each goal's performance level (i.e. “below expectations” performance pays 50%, “exceeds expectations” pays 125%), (6) establishing goal priority, timing, and weighting, (7) calculation of overall performance rating and (bonus) payout level at the end of the review period, and (8) documentation of the results of all the steps listed above.

12. The methodology of claim 11, wherein the said computerized application is used in conjunction with an application for the management of organizational charts.

13. The methodology of claim 11, wherein the said computerized application is used in conjunction with an application for the management of human resources.

14. The methodology of claim 11, wherein the said computerized application is used in conjunction with an application for the management of payroll, bonus payouts, and/or pay-for-performance payouts (i.e. commission pay, per-unit Pay).

15. The methodology of claim 11, wherein the said computerized application is used for specific sections of the organization.

16. The methodology of claim 11, wherein the said computerized application is used in conjunction with business unit dashboards or report scorecards.
